(19) United States
(12) Patent Application Publication
(10) Pub. No.: US 2010/0287031 A1
(43) Pub. Date: Nov. 11, 2010

(54) Method, Apparatus, System, and Computer Program for Selecting Replacement User Devices

(76) Inventor: Charles Mckenna, Helsinki (FI)

Correspondence Address: Hollingsworth & Funk, 8500 Normandale Lake Blvd., Suite 320, Minneapolis, MN, 55437, US

(21) Appl. No.: 12/437,409

(22) Filed: May 7, 2009

(51) Int. Cl. G06Q 10/00; G06Q 50/00; G06F 15/16; G06Q 99/00; G06Q 30/00

(52) U.S. Cl. 705/10; 709/206; 705/26; 705/1.1

(57) ABSTRACT

Selecting replacement user devices involves tracking user interactions with an apparatus on an ongoing basis and storing usage pattern data derived from the user interactions. A user-generated request to replace the apparatus with a different apparatus is received, causing the usage pattern data to be compared with features of available devices. A listing of recommended devices selected from the available devices is rendered on the apparatus in response to the request.

### TECHNICAL FIELD

This specification relates in general to electronic devices, and more particularly to systems, apparatuses, computer programs, and methods for assistance in selecting replacement user devices.

### BACKGROUND

Many electronic devices are subject to occasional replacement by users. In particular, mobile devices such as cell phones are commonly upgraded at regular intervals for a number of reasons. Such devices may be subject to harsher physical environments than stationary devices and so may show signs of significant wear after a year or two. Also, the pace of advancements in the mobile devices and associated service networks means that new capabilities and features are constantly being added, and users may need to buy new devices to take advantage of those capabilities and features.

Currently a user can choose their next device via a web site that describes the features of the new devices. These web sites may be provided by device manufacturers and mobile service providers. In such a case, there may be a large number of models and available options, resulting in many dozens of different devices to choose from. Sometimes the web site provides filters that allow the users to narrow the choices to include devices with features they want or think they need.

Because mobile device technologies are constantly being developed and improved, it is difficult for the average user to make an informed decision based on so many possible choices. In such an event, the users may be intimidated by the choices they must make, and may make choices based on other factors (e.g., discounts/specials, recommendations from friends). However, if the end user's particular needs are not taken into account during this process, he or she may not be satisfied with the ultimate choice.

### SUMMARY

The present specification discloses systems, apparatuses, computer programs, data structures, and methods for assistance in selecting replacement user devices. In one embodiment, a method, apparatus, and computer readable medium are capable of tracking user interactions with an apparatus on an ongoing basis. Usage pattern data derived from the user interactions are stored on the apparatus and a user-generated request to replace the apparatus with a different apparatus is received. The usage pattern data is compared with features of available devices, and a listing of recommended devices selected from the available devices is rendered in response to the request.

In more particular embodiments, the usage pattern data may be compared with services associated with the available devices, and a listing of recommended service providers associated with the recommended devices may be rendered. In other more particular embodiments, the features of the available devices may include a combination of battery life, screen size, telemetry devices, multimedia capture devices, user input devices, network interfaces, flash memory space, device price range, device form factor, and device complexity. In one case, the user interactions may include usage of a combination of applications, types of communication most frequently used, length of communication (either text or voice), processor bandwidth network bandwidth, media capture devices, and user interface devices. In another case, causing the usage pattern data to be compared with the features of available devices involves sending the usage pattern data to a network service provider that provides the listing of the recommended devices in response thereto.

In another embodiment of the invention, a method, apparatus, and computer readable medium enable receiving usage pattern data based on long-term user interactions that are tracked on an apparatus of a user. The usage pattern data is compared to features of available devices in response to a user-generated request to replace the apparatus with a different apparatus. A listing of recommended devices selected from the available devices is determined in response to the comparison, and the listing of recommended devices is sent to the apparatus.

In more particular embodiments, the usage pattern data may be compared with services associated with the available devices, and a listing of recommended service providers associated with the recommended devices may be sent to the apparatus. In other more particular embodiments, the features of the available devices may include a combination of battery life, screen size, telemetry devices, multimedia capture devices, user input devices, network interfaces, and device complexity. In one case, the user interactions may include usage of a combination of applications, processor bandwidth network bandwidth, media capture devices, and user interface devices.

In other more particular embodiments, the user may be placed into a category based on the usage pattern data, and the listing of recommended devices may be tailored based on the category. In such a case, the category may be selected from advanced and less-advanced users, and/or the category may be selected based on common usage patterns of other users that submit analogous usage pattern data. In the latter case, the listing of recommended devices may include links to a social networking site having content populated by the other users in the selected category and/or the user may be assigned an avatar associated with the selected category.

These and various other advantages and features are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments of the invention.

### BRIEF DESCRIPTION OF THE DRAWINGS

The invention is described in connection with example embodiments illustrated in the following diagrams.

FIG. 1 is a block diagram of a device recommendation architecture according to an example embodiment of the invention;

FIG. 2 is a block diagram of a service apparatus according to an example embodiment of the invention;

FIG. 3 is a block diagram of a mobile apparatus according to an example embodiment of the invention; and

FIGS. 4A-B and 5 are flowcharts illustrating procedures according to example embodiments of the invention.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present invention is generally related to an intelligent application that can recommend a replacement for an existing device based on usage of the existing device. With such an application, a user can easily be presented with optimal device choices based on their personal interactions the current device. The results can be presented with as much or little detail as provided, so that less technically savvy users can make informed choices without having to understand the underlying technologies and features in the new device. Other users who are more interested in the technical details may be able to view their current usage and see why the particular choices are presented. In such a case, the users may be able to see a mapping of current usage statistics to features/capacities, and in this way be provided with objective measures of how their experience could improve with the new device.

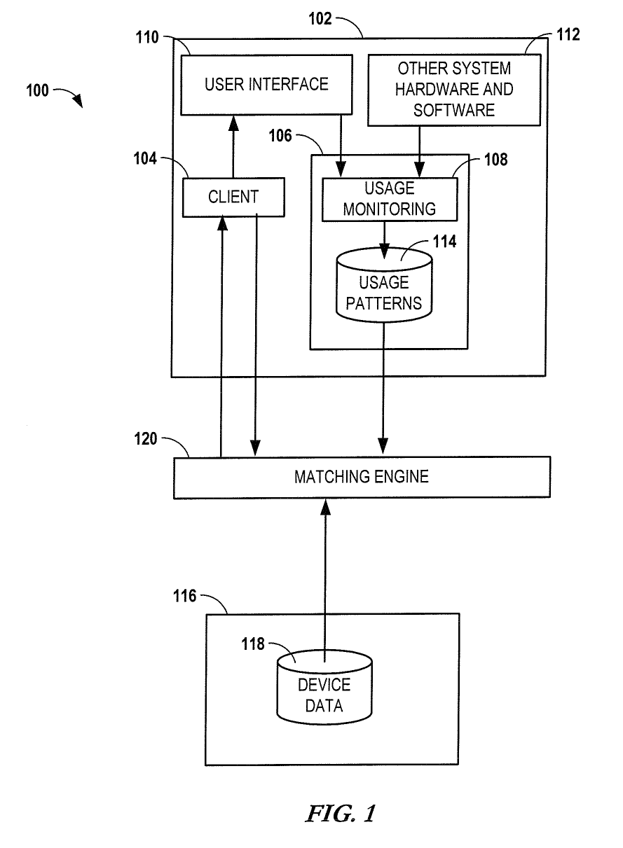

In reference now to FIG. 1, a block diagram illustrates an architecture 100 for intelligent device selection applications according to an example embodiment of the invention. The architecture 100 includes a client device 102 that, in whole or in part, may be a target for a further upgrade. A client application 104 and usage engine application 106 runs on the device 102. The client 104 may include user interface components (e.g., accessible via user interface 110) and can be used to signal an interest in finding an upgrade/replacement for device 102 as well as presenting options to the user of the device 102 in response to this signal.

The usage engine 106 may include a usage monitoring component 108 that tracks user activity that occurs on a user interface 110 and/or other system hardware and software 112 (e.g., network interfaces). The usage monitoring component 108 may compile usage patterns into a database 114. This database 114 may be continuously updated with usage data, which may be compiled into both short-term and long-term usage statistics/patterns. Generally, the statistics provide a picture of how the user (or users) uses the device 102 so that the architecture can determine, for example, what applications and/or performance characteristics may be important to a particular user of the device 102, and how a new device may improve the user experience in the future.

A service entity 116 may include a network accessible device database 118 that may be used for storing device data usable for selecting replacements for device 102. The device database 118 may include device data appropriately categorized to match various performance measures of the usage database 114. The device database 118 may be maintained by any combination of device manufacturers, software developers, network service providers, retailers, third party contributors, users, etc. The data in the individual usage database 114 and device database 118 are utilized by a matching engine 120 for providing upgrade recommendations to user of device 102.

The matching engine 120 is a service component that contains decision logic that provides the best phone recommendations to a user. The matching engine 120 may operate on the device 102, the service entity 116, or via a third party network entity (not shown). The matching engine 120 provides on-demand searching of one or more device databases 118, such as in response to a request from client 104. The device database 118 can be searched by the matching engine 120 using criteria derived from usage data 114 of the individual device 102. The results of such a search may be provided back to the client 104 which displays the results to a user via user interface 110.

The device database 118 may contain specific details related to newly available devices (e.g., processor power, battery life, screen size, text input method, network interfaces and capabilities, etc.) that are provided by manufacturers. The device database 118 may also contain normative data about device 102 and its equivalents. This data 118 about device 102 may include similar details as described above relative to the new devices (e.g., processor power, battery life, screen size, text input method, network interfaces and capabilities, etc.). The data 118 may also contain average usage data compiled from a number of devices similar to device 102. This average data may include such diverse measurements as average time to load web pages, number of emails accessed, average number of spelling errors while typing, amount of zooming and in-page navigation need to read document pages, inadvertent shutdowns due to low battery, etc. In this way, the locally collected usage data 114 can be compared against the average data to see if the user has some statistically different usage patterns that can be used as input to the matching engine 120.

In one scenario, a user purchases device 102 and uses the device 102 for some period of time. During this time, the usage monitoring 108 tracks and analyzes usage. The tracking operations performed by the monitor 108 are generally chosen/designed to be minimally invasive (e.g., cause negligible impact on device performance) as well being careful not to store or expose data that the user may consider private. The collected data may be processed into a compact, high-level descriptive form before being placed into usage database 114.

After some time (possibly many years), the user may be considering buying a new device to replace the device 102. The user (or a sales assistant) can open the client application 104, such as by selecting an icon that is accessible from a known location in the user interface 110 (e.g., system tools, control panel, etc.). The client 104 may first verify whether it is acceptable to divulge usage data 114, and may query the user regarding additional features, some of which may not exist on device 102 therefore about which no usage data would exist.

In response to the request, the client 104 may send usage data 114 to the matching engine 120, which compares this data against current offerings on device database 118. Recommendations are compiled and sorted, and sent back to the client 104 for rendered via the user interface 110. The client 104 may display recommendations directly, or use another program such as web browser to display the recommendations.

The device recommendations are based on the way the user uses their device. Someone who sends lots of long emails might be recommended to get a device with a full “qwerty” keyboard. Someone who takes a lot of pictures and transfers them off the device might be offered a device with a better camera. Someone who only sends SMS and makes phone calls might be recommended a less featured device that may at the same time be more compact, have better battery life and voice quality, have a simpler interface, etc.

The recommendations provided by the architecture 100 may be stated relative to the current device 102. They will show simple information like “device A has a bigger screen than your current device” or “device B is slimmer and lighter that your device.” A summary table might be presented highlighting the differences between current and potential replacements devices. The leaders in each category (e.g., row of the table) may be highlighted enabling the user to identify rankings for features they may find particularly important. For example, in a row of the table stating storage capacity, current device 102 may have 2 GB of storage, and new devices A and B have 10 GB and 20 GB, respectively. In such a case, the cell of device B would be highlighted relative to the other cells in the row.

The recommendations may also be presented relative to the user type. In one example, users may be categorized as advanced or less-advanced depending on how technologically savvy the user is. Whether a user is categorized as advanced may be due to a user choice (e.g., on a device profile) or based on particular usage patterns (e.g., choice of detailed/expert views on user interface, heavy use of advanced features, etc.). When presenting device recommendations, advanced users may see more detailed information. For example, an advanced user might see “This new device has an 8 megapixel camera with autofocus, compared to your present 2 megapixel camera with fixed focus.” Advanced users may also be presented with details of new features that do not exist on the user's current device (e.g., mini projector, mobile TV, etc.). There may be more emphasis on presenting devices with additional features for those users who are deemed to be advanced, as such users may be more up to date on the current technologies, or be more willing to learn about new features.

In contrast, the recommendations presented to a less-advanced user may use more simple comparisons, such as “The new phone will take pictures that are twice as clear as pictures taken from your current phone.” Although the new devices presented to the less-advanced user may also have new features not on the original device 102, such features may not figure so prominently in the recommendations so as not to overwhelm the user. The existence of such features may be posed as use case questions, such as “Do you want to watch TV on your device?” or “Do you want to use your device hands-free in the car?” If the user answers in the affirmative, then they may be presented with more detail (e.g., “Your carrier provides mobile TV for an extra fee,” “Your car may support hands free operation using Bluetooth technology; click here to find out if your car has this feature,” etc.) and may tailor results based on desire for the feature.

In one embodiment, the user could be categorized with other users based on usage. When the users request new device recommendations, they may be shown a summary of their phone usage presented as an avatar. For example, teenagers using mainly SMS and making short phone calls would be ranked as “Text Bunnies” and be shown an icon of their current character. Heavy music users could be ranked as “Nightingales,” users who make extensive use a camera phone (and possibly multimedia messaging services) could be ranked as “Shutterbugs,” etc.

These avatars could then be used on a social networking site to see what phones others with the same avatar had chosen and what those other users thought of them. For example, when presenting the recommendations, the user may be presented with a link saying “See what other Nightingales have bought.” The site may include blogs, comments, text messages (e.g., such as Twitter™) or other communications from others users also in the category to discuss the pros and cons of particular devices. Such other users may have upgraded from devices the same as or similar to current device 102. However, there need be no correlation between the current device 102 and what the others use, e.g., so long as the usage patterns between user of device 102 and the other users are related.

The recommendations provided by the architecture 100 may also specific to the device usage, such as consumption of persistent storage and usage of particular applications. So a user with many music files will be shown that the new device can hold ten times more music than their current device. Another user whose memory space is taken up mainly with pictures or videos, will be shown that the new device can hold ten times as many pictures and videos as their current device. Various combinations of such recommendations are also possible

As was previously mentioned above, the user's device may be monitored by an application that runs permanently as a background process in the device, as represented by usage monitoring component 108 in FIG. 1. The component 108 observes the usage of the devices features and the type of content in the device over long period of time. Multiple operational aspects can be monitored, such as voice, messaging, data, camera, application installations, processor and memory usage, power consumption, etc. Out of this monitoring, some critical data points that have may have an impact on choosing next device are stored, e.g., in database 114. A higher weight may be applied more recent activity.

When the user launches the client application 104, the usage parameters may be transferred to matching engine 120 (e.g., over a secure connection) for selecting optimal new device recommendations. In addition to usage patterns 114, current device model and device ownership time may be sent to the engine 120 to be taken into account. The matching engine 120 implements the logic for deciding which devices to present to the user. The matching engine 120 may also decide how on the recommendations are presented to the user. If the matching engine 120 (or client 104) deduces that the user is an advanced user, technical specs may be included in the information send back to the client phone. If the user is not an advanced user, more simple information can be sent.

The list of recommended devices may be sent back from the matching engine 120 to the client application 104 on device 102 using a secure connection, such as secure hypertext transport protocol (HTTPS). The user can then use the client application 104 to browse through the recommended phones and their features. In some embodiments, the raw log data (e.g., as collected by usage tracker 108) is not persistently stored in the database 114, nor would such data leave the device 102 in order to provide the recommendations. This should reduce privacy concerns. Only consolidated usage patterns are stored in the database 114 and transferred to determine the most suitable new devices.

In reference now to Table 1 below, an example is presented to show how various usage patterns may translate to device features. The first column in Table 1 shows the users actions that the system will observe. The second column shows the parameters that are counted when the actions are observed. The parameters with a “+” are counted for every usage or given a weighted value depending various factors, such as the number of existing files (e.g. music or pictures). The parameters with a “−” may be ignored or given a lower weighting. When there is a “&” in front, the parameter is set to its maximum value. It is the parameters in the second column that are transferred to the server to be used to decide which phones to recommend and how to present the recommendations.

TABLE 1

| Actions and Usage Observed | Influence on New Device |
|---|---|
| Only phone calls and text messaging used | &Simplicity &LowPrice |
| Takes pictures or video frequently | +Camera, +MemorySize |
| Views pictures and videos on device | +ScreenSize +Camera |
| frequently | |
| Images or Video are transferred off the | +HighResCamera +AutoFocusCamera |
| device | |
| Flash is enabled for many pictures | +HighIntensityFlash |
| Uses power hungry application. If user | +BatteryLife |
| spending a large amount of time making | |
| Video calls, or using the GPS, WLAN etc. | |
| Charges device infrequently. Device | +BatteryLife |
| frequently shuts down due to empty | |
| battery. | |
| Office applications used | +BusinessPhone |
| If used maps few times or several | &Maps +GPS |
| Landmarks | |
| If used GPS for navigation | &GPS |
| Uses lots of memory (for pictures, music | +MemorySize |
| etc) | |
| Lots of music files, user music player | +MusicPhone +NaviWheel |
| frequently | +Accessory −Simplicity |
| User roams frequently | +QuadBand |
| Lots of data transferred over the air | +HSDPA +WLAN |
| Uses WLAN frequently | &WLAN −Simplicity |
| Frequent Web Browsing | +ScreenSize +HSDPA +WLAN −Simplicity |
| Device inactive for long periods | +Simplicity +LowPrice |
| Device connected to PC frequently | +USBCharging −Simplicity |
| Sync's content to PC | −Simplicity |
| Frequent long SMS | +QwertyKeyboard |
| Many SMS or Emails stored | +NaviWheel |
| Frequent Email | +QwertyKeyboard +ScreenSize −Simplicity |
| MailForExchange used | +BusinessPhone |
| If wired accessory connected frequently | +Bluetooth |
| If Bluetooth accessory connected | &Bluetooth +BluetoothLowEnergy |
| frequently | |
| If current device already small in size | +LightWeight −ScreenSize |
| Applications installed | −Simplicity |
| Instant Messaging used | +IM −Simplicity |
| If connected to car kit frequently | +Bluetooth +SimAccessProfile |
| Auto detect of device orientation enabled | &Accelerometers |

The logic for deciding the best new phone for a user can be implemented on the handset side or the server side. If there are privacy issue with sending user profile data to the server, the server can do some pre filtering of devices based on the current device the user has (e.g., device 102), and then let the application on the device (e.g., client 104 and/or matching engine 120) do usage-based filtering.

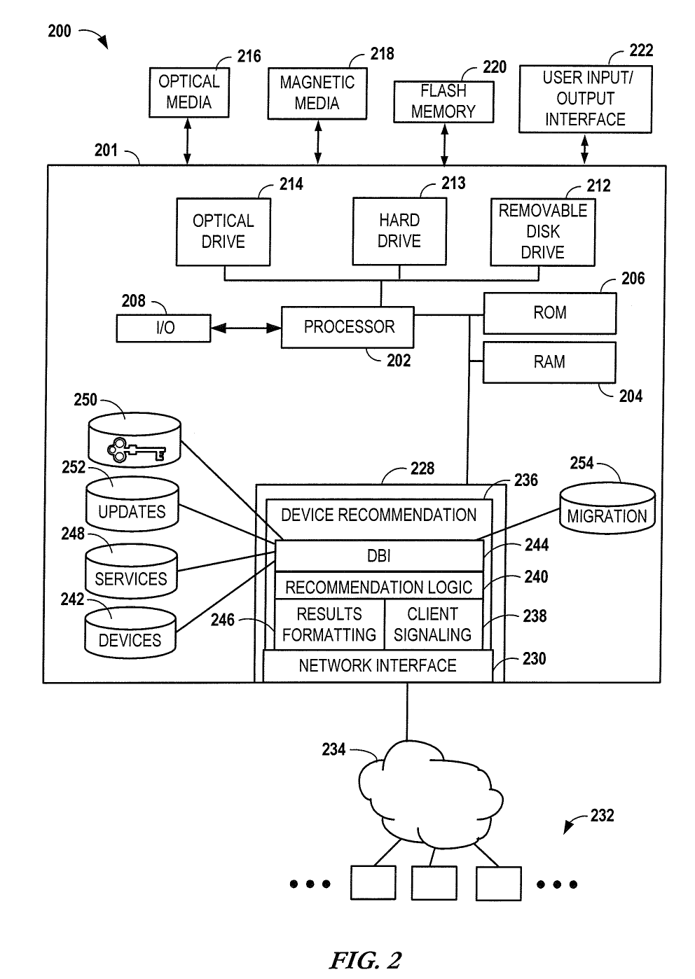

In reference now to FIG. 2, a block diagram provides details of a network service 200 that provides device recommendation services according to example embodiments of the invention. The service 200 may be implemented via one or more conventional computing arrangements 201. The computing arrangement 201 may include custom or general-purpose electronic components. The computing arrangement 201 include one or more central processors (CPU) 202 that may be coupled to random access memory (RAM) 204 and/or read-only memory (ROM) 206. The ROM 206 may include various types of storage media, such as programmable ROM (PROM), erasable PROM (EPROM), etc. The processor 202 may communicate with other internal and external components through input/output (I/O) circuitry 208. The processor 202 may include one or more processing cores, and may include a combination of general-purpose and special-purpose processors that reside in independent functional modules (e.g., chipsets). The processor 202 carries out a variety of functions as is known in the art, as dictated by fixed logic, software instructions, and/or firmware instructions.

The computing arrangement 201 may include one or more data storage devices, including removable disk drives 212, hard drives 213, optical drives 214, and other hardware capable of reading and/or storing information. In one embodiment, software for carrying out the operations in accordance with the present invention may be stored and distributed on optical media 216, magnetic media 218, flash memory 220, or other form of media capable of portably storing information. These storage media may be inserted into, and read by, devices such as the optical drive 214, the removable disk drive 212, I/O ports 208 etc. The software may also be transmitted to computing arrangement 201 via data signals, such as being downloaded electronically via networks, such as the Internet. The computing arrangement 201 may be coupled to a user input/output interface 222 for user interaction. The user input/output interface 222 may include apparatus such as a mouse, keyboard, microphone, touch pad, touch screen, voice-recognition system, monitor, LED display, LCD display, etc.

The service 200 is configured with software that may be stored on any combination of memory 204 and persistent storage (e.g., hard drive 213). Such software may be contained in fixed logic or read-only memory 206, or placed in read-write memory 204 via portable computer-readable storage media and computer program products, including media such as read-only-memory magnetic disks, optical media, flash memory devices, fixed logic, read-only memory, etc. The software may also placed in memory 206 by way of data transmission links coupled to input-output busses 208. Such data transmission links may include wired/wireless network interfaces, Universal Serial Bus (USB) interfaces, etc.

The software generally includes instructions 228 that cause the processor 202 to operate with other computer hardware to provide the service functions described herein. The instructions 228 include a network interface 230 that facilitates communication with user devices 232 of a data network 234. The network interface 230 may include a combination of hardware and software components, including media access circuitry, drivers, programs, and protocol modules. The network interface 230 may also include software modules for handling one or more network common network data transfer protocols, such as HTTP, file transfer protocol (FTP), simple mail transport protocol (SMTP), short message service (SMS), multimedia message service (MMS), etc.

The network interface 230 may be a generic module that supports specific network interaction between user devices 232 and device recommendation module 236. The device recommendation module 236 includes a client interaction module 238 that is configured to receive signals and data from user devices 232 related to upgrades of those devices 232. These signaling and data transfer actions may be received via network interface 230 using standard network protocols such as HTTP, FTP, etc., and passed to recommendation logic 240 for further processing.

The recommendation logic 240 may perform many core functions of the module 236, including processing and modification of incoming usage data from devices 232, mapping of usage data to features contained within device database 242 (which are accessed via database interface 244), applying weightings to usage data, and extracting recommendations which may be sent to results formatting component 246 for further processing. The device database 242 may be maintained by one or more manufacturers, service providers, and/or similar entities. The logic 240 may also be configured to provide service data (e.g., cellular network service) as part of recommendation, in which case a services database 248 may be accessed in a manner similar to that of the device database 242. The services database 248 may also include other non-technical service data that may help users decide on a device, such as warranty, availability of retail stores with technical expertise in selected devices, special offers, etc.

The results formatting component 246 may receive a raw list of recommended devices/services from the recommendation logic 240 and prepare the results in a format that is appropriate to the target device and/or user. The descriptive detail in the results may be modified based on user expertise, such as by providing more advanced users with more detailed technical specifications. The results may be localized for language, available or authorized vendors, protocols/capabilities of requesting devices 232, etc., all of which may be taken into account by the formatter 246. The formatter may insert content, such as images, links of places to preview and purchase devices, as well as comparisons to features that are specific to requesting device 232. The results may be sent using standard protocols via interface 230.

The recommendation logic 240 may perform other core functions of the recommendation module 236, including managing transaction security, as represented by security database 252. The security database 252 may include keys for conducting secure transactions, and may also be used for user authentication by client signaling component 238. Users may be authenticated locally on devices 232 or may have some authentication with related accounts associated with service 200. The devices 232 themselves may also have authentication data, e.g., hardware codes such as media access control (MAC) addresses that may be used to ensure correct devices models and configurations.

Another common function that may be provided by service 200 is to ensure that data provided via client signaling component 238 is in compatible with ongoing updates to service software, protocols, schemas, and formats utilized by the service 200. The client signaling component 238 may be able to push updates to devices 232 in order to update usage gathering software, data compilation parameters, data reporting schema, etc. As a result, an updates database 252 may be consulted to track/supply updates to various device models and versions.

In another embodiment, the service 200 may also be part of an end-to-end e-commerce solution that allows the consumer to not only be presented with recommended replacements/upgrades, but to also purchase those devices in the same transaction. For example, the results formatter 246 may provide links to an e-commerce site where new devices can be purchased, as well as activation of new or modified network service. In another arrangement, the service 200 may include a self-contained e-commerce module (not shown) for performing these functions.

One advantage in providing an end-to-end solution for upgrading devices is that migration to the new device can be made easier. One problem users face in moving to a new device is that all the user information, such as bookmarks, contacts, email account access and authentication data, Wi-Fi access point data, local time zone, customized spell check dictionaries, stored songs/photos, etc., must be manually moved to the new device by the user, if such data can be moved at all. However, the usage tracking and upgrade clients in the devices 232 can also be configured to send data that enables pre-configuring the new device. In such a case, the client signaling component (or other component) can be adapted to facilitate upload of user data from devices 232 to a migration database 254.

The migration database 254 may contain user data in the most generic form possible so as to be easily converted between a large number of different devices. Markup languages such as hypertext markup language (HTML) and extensible markup language (XML) may be useful for textual data such as contacts, account access and authentication, etc. Other common binary formats may be used for storing data such as photos and music. It will be appreciated that transcoding digitized media may cause degradation in rendering quality. Thus it may be beneficial to store binary data in the database 254 in its original format, and only convert to a different format if needed by the new device.

By integrating the recommendation logic 240 with e-commerce and device preconfiguration functions, the user of devices 232 can not only easily choose what upgrades/replacement devices best suit them, but can also facilitate easy migration to the new device. Ideally, the user would be able receive the new device in the mail, transfer subscriber identity module (SIM) card to the new device, and use the device “out of the box” as a replacement for the previous device without performing any extra configuration or data transfer.

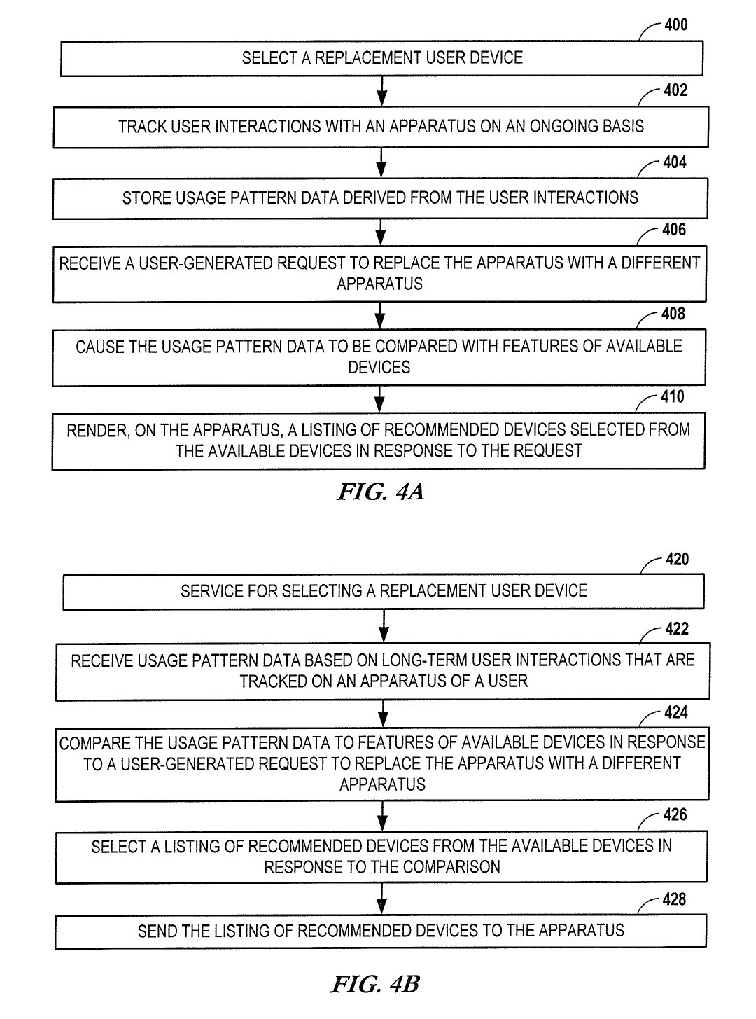

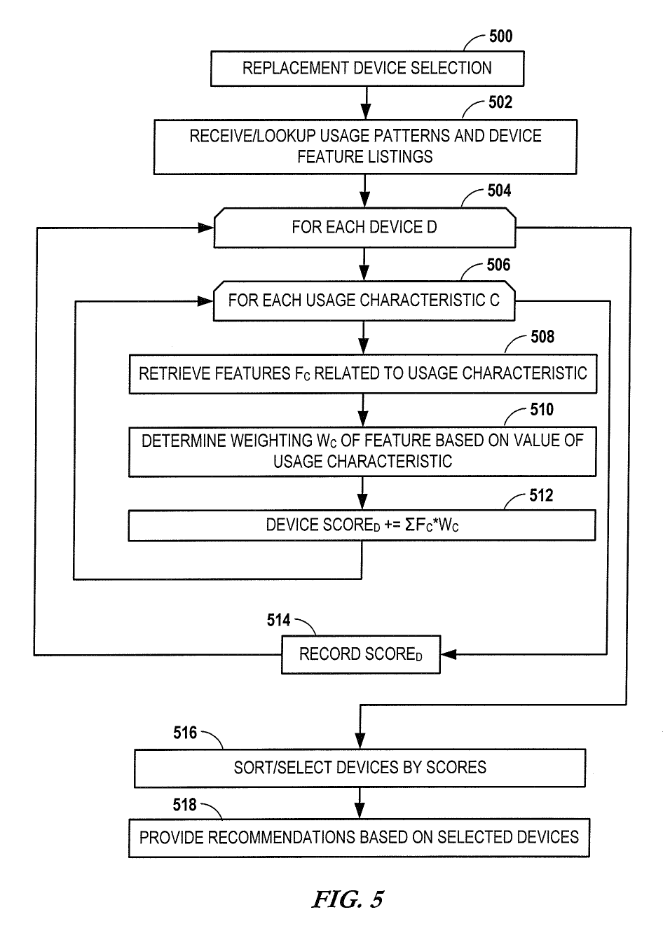

For purposes of illustration, the operation of the service 200 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 201 is only a representative example of network infrastructure hardware that can be used to provide device selection services as described herein. Generally, the functions of the computing service 200 can be distributed over a large number of processing and network elements, and can be integrated with other services, such as Web services, gateways, mobile communications messaging, etc. For example, some aspects of the service 200 may be implemented in user devices and/or intermediaries such as shown in FIG. 1, and the service may incorporate functions such as described below in relation to FIGS. 4A-B and 5.

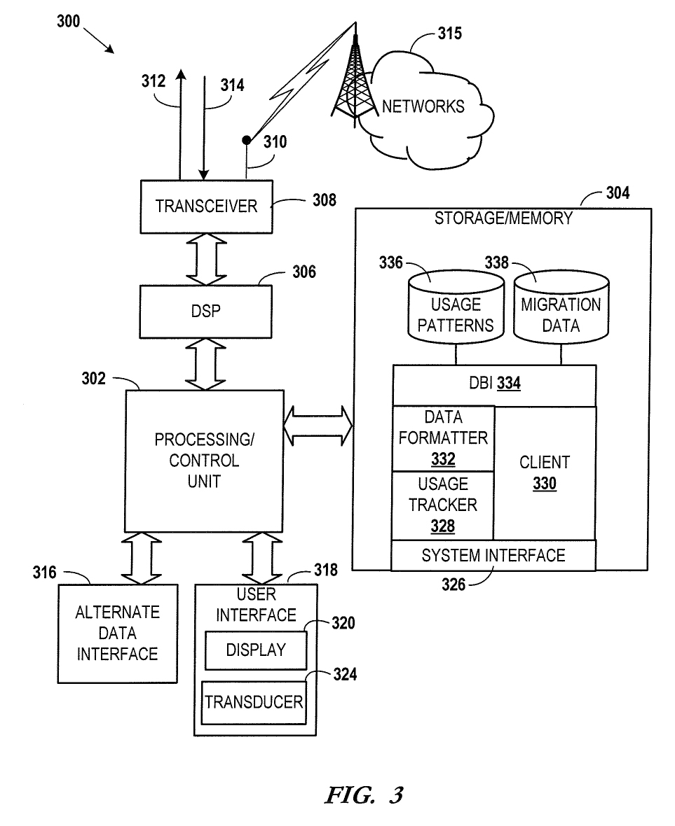

Many types of apparatuses may include features that allow tracking usage for purposes of suggest replacement devices as described herein. Users are increasingly using mobile communications devices (e.g., cellular phones), and these devices are often replaced on a regular basis. In reference now to FIG. 3, an example embodiment is illustrated of a representative mobile apparatus 300 capable of carrying out operations in accordance with example embodiments of the invention. Those skilled in the art will appreciate that the example apparatus 300 is merely representative of general functions that may be associated with such devices, and also that fixed computing systems similarly include computing circuitry to perform such operations.

The user apparatus 300 may include, for example, a mobile apparatus, mobile phone, mobile communication device, mobile computer, laptop computer, desk top computer, phone device, video phone, conference phone, television apparatus, digital video recorder (DVR), set-top box (STB), radio apparatus, audio/video player, game device, positioning device, digital camera/camcorder, and/or the like, or any combination thereof. Further the user apparatus 300 may include features of the mobile apparatus 102 shown and described in FIG. 1 and capable of performing functions such as described below regarding FIGS. 4A-B and 5.

The processing unit 302 controls the basic functions of the apparatus 300. Those functions associated may be included as instructions stored in a program storage/memory 304. In an example embodiment of the invention, the program modules associated with the storage/memory 304 are stored in non-volatile electrically-erasable, programmable read-only memory (EEPROM), flash read-only memory (ROM), hard-drive, etc. so that the information is not lost upon power down of the mobile terminal. The relevant software for carrying out operations in accordance with the present invention may also be provided via computer program product, computer-readable medium, and/or be transmitted to the mobile apparatus 300 via data signals (e.g., downloaded electronically via one or more networks, such as the Internet and intermediate wireless networks).

The mobile apparatus 300 may include hardware and software components coupled to the processing/control unit 302. The mobile apparatus 300 may include multiple network interfaces for maintaining any combination of wired or wireless data connections. The illustrated mobile apparatus 300 includes wireless data transmission circuitry for performing network data exchanges. This wireless circuitry includes a digital signal processor (DSP) 306 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 308, generally coupled to an antenna 310, transmits the outgoing radio signals 312 and receives the incoming radio signals 314 associated with the wireless device. These components may enable the apparatus 300 to join in one or more communication networks 315, including mobile service provider networks, local networks, and public networks such as the Internet and the Public Switched Telephone Network (PSTN).

The mobile apparatus 300 may also include an alternate network/data interface 316 coupled to the processing/control unit 302. The alternate data interface 316 may include the ability to communicate via secondary data paths using any manner of data transmission medium, including wired and wireless mediums. Examples of alternate data interfaces 316 include USB, Bluetooth, RFID, Ethernet, 302.11 Wi-Fi, IRDA, Ultra Wide Band, WiBree, GPS, etc. These alternate interfaces 316 may also be capable of communicating via the networks 315, or via direct and/or peer-to-peer communications links.

The processor 302 is also coupled to user-interface hardware 318 associated with the mobile terminal. The user-interface 318 of the mobile terminal may include a display 320, such as a light-emitting diode (LED) and/or liquid crystal display (LCD) device. The user-interface hardware 318 also may include a transducer 324, such as an input device capable of receiving user inputs. The transducer 324 may also include sensing devices capable of measuring local conditions (e.g., location temperature, acceleration, orientation, proximity, etc.) and producing media (e.g., text, still pictures, video, sound, etc). Other user-interface hardware/software may be included in the interface 318, such as keypads, speakers, microphones, voice commands, switches, touch pad/screen, pointing devices, trackball, joystick, vibration generators, lights, accelerometers, etc. These and other user-interface components are coupled to the processor 302 as is known in the art.

The program storage/memory 304 includes operating systems for carrying out functions and applications associated with functions on the mobile apparatus 300. The program storage 304 may include one or more of read-only memory (ROM), flash ROM, programmable and/or erasable ROM, random access memory (RAM), subscriber interface module (SIM), wireless interface module (WIM), smart card, hard drive, computer program product, and removable memory device. The storage/memory 304 may also include one or more hardware interfaces 323. The interfaces 323 may include any combination of operating system drivers, middleware, hardware abstraction layers, protocol stacks, and other software that facilitates accessing hardware such as user interface 318, alternate interface 316, and network hardware 306, 308.

The storage/memory 304 of the mobile apparatus 300 may also include specialized software modules for performing functions according to example embodiments of the present invention. For example, the program storage/memory 304 includes a system interface 326 that enables access to usage of various hardware and software components of the apparatus 300. A usage tracker 328 may use this interface to track relevant user actions as described hereinabove. The system interface 326 may also include drivers and system utilities of an operating system, and may provide network access service for functional components such as an upgrade recommendation client 330.

Generally, the usage tracker 328 may run as a lightweight background process that tracks device usage of interest, such as accesses to features, applications, networks, external devices, user interface hardware 318, etc., and may also track performance data such a processor and network bandwidth, power consumption, location, etc. This data can be sent to and processed by a data formatter 332, which compiles the raw usage data into a compact summary form that may also remove or obfuscate privacy data, such as text entered into user interface 318, identities of communication endpoints, location/time combinations, etc.

The data formatter 332 may place this summary data into a usage database 336 via a database interface 334. This may also involve accessing already stored data 336 for purposes as calculating running averages and other time dependent trends. This data 336 may be maintained for a long period of time until needed by the client 330.

The client 330 is a user application that may not be accessed for most of the lifetime of the device 300. The client 330 may need to be accessed only when the user decides it is time to replace the device 300 with an upgraded unit. The client 330 generally accesses locally stored usage data 336 and may send this out to a network service (e.g., service 200 in FIG. 2) for further processing to determine likely candidates for replacement based on measured usage patterns. Alternatively, the client 330 may include logic that allows the device 300 to internally determine the recommendations, but still may access such network service to obtain a list of currently available devices and services from which to choose.

As mentioned above in relation to the service entity shown in FIG. 2, the client 330 may, by itself or through another application (e.g., browser), present recommended results to user via user interface 318. These recommendations may be part of an end-to-end transaction that facilitates purchase and pre-configuration of a replacement device all from the same mobile apparatus 300. The client 330 (or other system component) may access migration data 338 that allows collecting, protecting (e.g., via encryption) and sending user data to a remote service. Ideally the migration data 338 can be converted into other formats (if needed) and installed to a new device on the production line or via a third party service (e.g., distributor, vendor). The migration data 338 might also provide a convenient entry point from which to purge the data from the device 300 once the user is satisfied the new device meets expectations and that all data has successfully be transferred to the new device without loss or corruption.

The mobile apparatus 300 of FIG. 3 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

In reference now to FIG. 4A, a flowchart illustrates a procedure 400 for selecting a replacement user device according to an example embodiment of the invention. The procedure involves tracking 402 user interactions with the apparatus on an ongoing basis and storing 404 usage pattern data derived from the user interactions. A user-generated request to replace the apparatus with a different apparatus is received 406. The usage pattern data is caused to be compared 408 with features of available devices. This comparison 408 may occur via a network service and/or on a user's device. A listing of recommended devices selected from the available devices is rendered 410 on the apparatus in response to the request.

In FIG. 4B, a flowchart illustrates a procedure 420 for selecting a replacement user device according to an example embodiment of the invention. The procedure involves receiving 422 usage pattern data based on long-term user interactions that are tracked on an apparatus of a user. The usage pattern data is compared 424 to features of available devices in response to a user-generated request to replace the apparatus with a different apparatus. A listing of recommended devices is selected 426 from the available devices in response to the comparison, and the listing of recommended devices is sent 428 to the apparatus.

In reference now to FIG. 5, a flowchart illustrates a procedure 500 for a replacement device selection service according to an example embodiment of the invention. The procedure involves receiving 502 (and/or looking up) usage patterns and device feature listings. Loops 504 and 506 iterate through devices and usage characteristics, respectively. For each usage characteristic, device features related to the usage characteristic are retrieved 508, e.g., via mapping such as shown in Table 1 hereinabove. Such a mapping may be used to determine 510 a weighting for the feature(s). For a given usage characteristic, there may be multiple features and associated weightings.

The sum of weighted feature values for each usage characteristic are added 512 to a running total that will form a score for the device. After completing the iteration 506 through the usage characteristics, the total score is recorded 514 for the particular device. After the iteration 504 through the devices is complete, devices can be sorted and/or selected 516 based on the scores. The selected devices are provided 518 to the requester, such as in the form of a markup-language document. Such as document may include additional information related to the selected devices, such as images, links to purchase and migrate current device data, etc.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus, comprising:
a processor configured with instructions that when executed by the processor cause the apparatus to:
track user interactions with the apparatus on an ongoing basis;
store on the apparatus usage pattern data derived from the user interactions;
receive a user-generated request to replace the apparatus with a different apparatus;
cause the usage pattern data to be compared with features of available devices; and
render a listing of recommended devices selected from the available devices in response to the request.

2. The apparatus of claim 1, wherein the processor further causes the apparatus to:
cause the usage pattern data to be compared with services associated with the available devices; and
render a listing of recommended service providers associated with the recommended devices.

3. The apparatus of claim 1, wherein the features of the available devices include a combination of battery life, screen size, telemetry devices, multimedia capture devices, user input devices, network interfaces, and device complexity.

4. The apparatus of claim 1, wherein the user interactions include usage of a combination of applications, processor bandwidth network bandwidth, media capture devices, and user interface devices.

5. The apparatus of claim 1, wherein causing the usage pattern data to be compared with the features of available devices comprises sending the usage pattern data to a network service provider that provides the listing of the recommended devices in response thereto.

6. A method, comprising:
tracking user interactions with a apparatus on an ongoing basis;
storing on the apparatus usage pattern data derived from the user interactions;
receiving a user-generated request to replace the apparatus with a different apparatus;
causing the usage pattern data to be compared with features of available devices; and
rendering, on the apparatus, a listing of recommended devices selected from the available devices in response to the request.

7. The method of claim 6, further comprising:
causing the usage pattern data to be compared with services associated with the available devices; and
rendering a listing of recommended service providers associated with the recommended devices.

8. The method of claim 6, wherein the features of the available devices include a combination of battery life, screen size, telemetry devices, multimedia capture devices, user input devices, network interfaces, and device complexity.

9. The method of claim 6, wherein the user interactions include usage of a combination of applications, processor bandwidth network bandwidth, media capture devices, and user interface devices.

10. The method of claim 6, wherein causing the usage pattern data to be compared with the features of available devices comprises sending the usage pattern data to a network service provider that provides the listing of the recommended devices in response thereto.

11. A computer-readable storage medium encoded with instructions that, when executed by an apparatus, perform the method of claim 1.

12. A method, comprising:
receiving usage pattern data based on long-term user interactions that are tracked on an apparatus of a user;
comparing the usage pattern data to features of available devices in response to a user-generated request to replace the apparatus with a different apparatus;
determining a listing of recommended devices selected from the available devices in response to the comparison; and
sending the listing of recommended devices to the apparatus.

13. The method of claim 12, further comprising:
comparing the usage pattern data to services associated with the available devices; and
sending to the apparatus a listing of recommended service providers associated with the recommended devices.

14. The method of claim 12, wherein the features of the available devices include a combination of battery life, screen size, telemetry devices, multimedia capture devices, user input devices, network interfaces, and device complexity.

15. The method of claim 12, wherein the long-term user interactions include usage of a combination of applications, processor bandwidth network bandwidth, media capture devices, and user interface devices.

16. The method of claim 12, further comprising:
placing the user into a category based on the usage pattern data; and
tailoring the listing of recommended devices based on the category;

17. The method of claim 16, wherein the category is selected from advanced and less-advanced users.

18. The method of claim 16, wherein the category is selected based on common usage patterns of other users that submit analogous usage pattern data.

19. The method of claim 18, further comprising including in the listing of recommended devices links to a social networking site having content populated by the other users in the selected category.

20. The method of claim 18, wherein the user is assigned an avatar associated with the selected category.
